(19) United States
(12) Patent Application Publication
(10) Pub. No.: US 2006/0128322 A1
(43) Pub. Date: Jun. 15, 2006

(54) Transceiver apparatus and module

(76) Inventors: Yutaka Igarashi, Yokohama (JP); Makoto Katagishi, Chigasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/297,318

(22) Filed: Dec. 9, 2005

(30) Foreign Application Priority Data
Dec. 10, 2004 (JP) 2004-357538

(51) Int. Cl. H04B 1/44

(52) U.S. Cl. 455/78

(57) ABSTRACT

It is possible to facilitate design and reduce a size and power dissipation of a radio frequency integrated circuit RFIC for full duplex system, by forming a duplexer for passing only a desired band, a low noise amplifier circuit LNA for amplifying an output signal of the duplexer, and a BPF for passing only a desired band in an output signal of the LNA in the same module and preventing a leak level of a transmission signal to a receiver side from affecting the design of the RFIC.

### INCORPORATION BY REFERENCE

The present application claims priority from Japanese application JP2004-357538 filed on Dec. 10, 2004, the content of which is hereby incorporated by reference into this application.

### BACKGROUND OF THE INVENTION

The present invention relates to a transceiver apparatus. In particular, the present invention relates to components for facilitating the design and reducing the size and power dissipation of radio frequency integrated circuits for full duplex system.

Conventional radio frequency circuits are formed using discrete components for each of function blocks (such as amplifiers for amplifying signals, mixers for converting signal frequencies, and filters for passing only desired bands of signals). Owing to the improvement of semiconductor techniques in recent years, it has become possible to integrate a plurality of function blocks included in the radio frequency signal circuit into one semiconductor chip (hereafter referred to as RFIC). The radio frequency circuit integrated into one or several semiconductor chips converts a high frequency signal received from an antenna to a signal in a lower frequency band with high qualities (such as low noise, high linearity, and suppression of signals in bands other than a desired band).

For implementing the radio frequency circuit at low cost, it is necessary to integrate a larger number of function blocks included in the radio frequency circuit into a single semiconductor chip. As one of obstacles to this purpose, it can be mentioned to integrate a filter circuit for suppressing signals in bands other than the desired band into the semiconductor chip. In general, a SAW (Surface Acoustic Wave) filter, a dielectric filter, or the like is used as this filter circuit. As a result, signals in bands other than the desired band are suppressed. However, the SAW filter or the dielectric filter cannot be integrated into the semiconductor chip.

Radio frequency circuits using discrete components typically have a configuration called super heterodyne, and need SAW filters or dielectric filters. However, these filters cannot be integrated into the semiconductor chip. If a radio frequency circuit manufactured using semiconductor has the super heterodyne configuration, therefore, SAW filters or dielectric filters are attached to the outside of the semiconductor chip. This increases the number of components and the area for mounting.

Therefore, a radio frequency circuit scheme that utilizes the advantage of the semiconductor circuit (although absolute values of component constants vary between semiconductor chips, relative values of component constants in one semiconductor chip coincide with specified values with high precision) and that does not need SAW filters or dielectric filters has been proposed. This is a zero IF (direct conversion) scheme or a low IF scheme. Either of them does not need SAW filters or dielectric filters attached to the outside, and suppression of signals that are present in bands other than the desired band is conducted by a filter that can be integrated into the semiconductor chip. It sometimes becomes necessary to attach partial filters to the outside because of requirements from the radio scheme or the system.

The basic principle of the zero IF scheme and the low IF scheme is described, for example, in DIRECT CONVERSION RECEIVERS IN WIDE-BAND SYSTEMS, written by Aarno Parssinen and published by Kluwer Academic Publishers.

On the other hand, expansion of communication frequencies is being studied or executed in order to cope with an increase in the number of subscribers of portable telephone and enrichment of communication contents. For example, in the W-CDMA scheme in the 3GPP (3rd Generation Partnership Project) standards, communication bands of six kinds ranging from Band-I to Band-VI are prescribed and communication can be conducted in a band that is suitable according to radio wave utilization situations and plans in various countries (ETSI TS 125 101). If in this case each portable telephone terminal has a function of coping with a plurality of bands, convenience in the situations such as international roaming is enhanced. Therefore, demands for the multi-band function are increasing.

### SUMMARY OF THE INVENTION

In the portable telephone terminal, the full duplex system conducts transmission and reception simultaneously. Even if the zero IF or low IF is used, therefore, it is difficult to suppress a transmission signal having a high level by using only the RFIC especially as multi-band implementation is promoted. If a transmission signal having a high level is present, receiver sensitivity for a received signal is degraded by an interference component as shown in FIGS. 3A-3C. FIGS. 3A-3C show examples in which the transmission signal is assigned to a frequency band lower than the received signal, in a frequency arrangement often used in portable telephones.

In FIG. 3A, reference numeral 1 denotes a transmission signal, 2 a received signal, 3 an interference signal, and 4 intermodulation interference caused on a receiver channel by the transmission signal 1 and the interference signal 3. The interference signal 3 is present in a frequency band that is nearly in the middle between the transmission signal 1 and the interference signal 3. It is now supposed that the transmission signal 1 and the received signal 2 are modulated signals (hereafter referred to as modulated waves) and the interference signal 3 is a signal that is not modulated (hereafter referred to as CW). Therefore, the transmission signal 1 and the received signal 2 are shown to each have a certain bandwidth, and the interference signal 3 is shown to be a line spectrum.

Denoting a frequency of the transmission signal 1 by ftx, and a frequency of the interference signal 3 by fjam, a frequency fi of the intermodulation interference 4 caused on the receiver channel by the transmission signal 1 and the interference signal 3 is represented by the following Equation (1).
fi=2fjam−ftx (1)

Intermodulation interference also occurs in the case shown in FIG. 3B. In FIG. 3B, signals similar to those shown in FIG. 3A are denoted by the same numerals as those in FIG. 3A, and description of them will be omitted. In this case, fi is represented by the following Equation (2).
fi=2ftx−fjam (2)

In the case of FIG. 3B, intermodulation interference 4 caused on the receiver channel by the transmission signal 1 and the interference signal 3 has a bandwidth that is twice the bandwidth of the intermodulation interference shown in FIG. 3A.

If the interference signal is in close vicinity to the receiver band, the received signal is subjected to influence of cross modulation distortion as shown in FIG. 3C. In FIG. 3C, signals similar to those shown in FIG. 3A are denoted by the same numerals as those in FIG. 3A, and description of them will be omitted. In FIG. 3C, reference numeral 5 denotes cross modulation interference 4 caused on the receiver channel by the transmission signal 1 and the interference signal 3. Cross modulation interference 5 having a bandwidth that is twice that of the transmission signal 1 and a center frequency of fjam is caused by the cross modulation distortion. Since the cross modulation interference 5 is mixed into the receiver channel, the receiver sensitivity is degraded.

Since the receiver sensitivity degradation shown in FIGS. 3(a)-3(c) can be reduced by suppressing the transmission signal with a filter, a configuration as shown in FIG. 4 is used.

In FIG. 4, reference numeral 10 denotes an antenna, 20 a duplexer, 30 a LNA (low noise amplifier), 40 a BPF (band pass filter), 50 an RFIC (radio frequency integrated circuit), 60 a BPF, 70 a PA (power amplifier), and 80 an isolator. As for a radio frequency signal input from the antenna 10, signals in bands other than the desired band are suppressed by the duplexer 20. A resultant signal is input to the LNA 30. The LNA 30 amplifies the output signal of the duplexer 20 so as to prevent the signal-to-noise ratio (hereafter referred to as SNR) from being degraded as far as possible. An output signal of the LNA 30 is input to the BPF 40. The BPF 40 suppresses signals in bands other than the desired band, and outputs a resultant signal to the RFIC 50.

The RFIC 50 conducts processing on the radio frequency signal by using a receiver scheme such as the zero IF or the low IF. Furthermore, the RFIC 50 outputs signals for changing over a gain and a bias current of the LNA 30, and thereby changes over the gain and the bias current according to the receiver level.

Since the RFIC 50 is intended for the full duplex system, the RFIC 50 conducts transmission simultaneously with the reception. As for a transmission signal output from the RFIC 50, signals in bands other than the desired band are suppressed by the BPF 60. A resultant signal is input to the PA 70. The PA 70 amplifies the transmission signal to a desired level, and outputs a resultant signal to the isolator 80. The isolator 80 is provided to cause the PA 70 to be capable of conducting power amplification efficiently even under an impedance variation of the antenna 10. The impedance variation of the antenna 10 is caused when, for example, the portable telephone is used with the antenna in contact with the head.

An output of the isolator 80 is output from the antenna 10 via the duplexer 20.

When seen from the receiver side (the input of the LNA 30), the duplexer 20 has an effect of suppressing the transmission signal (i.e., suppressing all signals in bands other than the receiver band). When seen from the transmission side (the output of the isolator 80), the duplexer 20 has an effect of suppressing spurious signals supplied from the receiver side (i.e., suppressing all signals in bands other than the transmission band). As a result, interference shown in FIGS. 3A-3C is reduced.

If a multi-band configuration is implemented in FIG. 4, integration of the BPF 40 is difficult. As a result, as many output terminals of the LNA 30 to the BPF 40 as correspond to the number of bands and as many input pins to the RFIC 50 from the BPF 40 as correspond to the number of bands become necessary. Therefore, the number of pins increases, resulting in an increase of the package size of the RFIC 50. Accordingly, the area of mounting becomes large.

The current consumed by the LNA 30 depends on the transmission signal suppression degree Ltxrx [dB] of the duplexer 20. It is now supposed that the transmission signal level at the output of the isolator 80 is Ptx [dBm] and the power gain of the LNA 30 is PG_LNA [dB]. It is also supposed that each port impedance of the duplexer 20, the input impedance and output impedance of the LNA 30, the output impedance of the isolator 80, and the input impedance of the BPF 40 is 50Ω. At this time, an input level P_LNAout [dBm] of the BPF 40 is represented by the following Equation (3).
P_{—}LNAout=Ptx−Ltxrx+PG_{—}LNA (3)

FIG. 5 shows the bias current of the LNA 30 as a function of P_LNAout. Since P_LNAout depends on the leak level of the transmission signal to the receiver side, the bias current of the depends on Ltxrx. This is shown in FIG. 6.

From FIG. 6, it is appreciated that the bias current of the LNA 30 depends on the transmission signal suppression degree Ltxrx of the duplexer 20. For integrating the LNA 30 into the RFIC 50, therefore, it is necessary to determine the bias current of the LNA 30 according to the dB value of Ltxrx. If Ltxrx is determined, however, it is necessary to sell the RFIC 50 and the duplexer 20 as a set solution. On the other hand, if it is attempted to design the RFIC 50 so as to make it usable with any value of Ltxrx, it is necessary to make the bias current of the LNA 30 variable in a wide range. Under the current techniques, it is very difficult to design the LNA 30 so as to attain a constant gain under a wide range of the bias current. It is also difficult to design the LNA 30 so as to obtain stability under every bias current.

Therefore, it is desirable that the RFIC 50 and the LNA 30 are separated from each other and a designer who selects the duplexer designs the LNA 30 as well. In the multi-band implementation, however, we cannot help utilizing an LNA IC having as many LNAs 30 as correspond to the number of bands integrated therein, from the viewpoint of the mounting area. Since in general the designer of the LNA IC is also different from the selector of the duplexer in the same way as the designer of the RFIC 50, however, the difficulty that the design that does not depend on Ltxrx must be conducted occurs in the same way.

In accordance with the present invention, the problems are solved by a module that can be applied to a transceiver apparatus, the transceiver apparatus including an antenna, a duplexer for passing only a desired band in a signal from the antenna or a signal to the antenna, a low noise amplifier circuit for amplifying an output signal of the duplexer, a first band pass filter for passing only a desired band in an output signal of the low noise amplifier circuit, a radio frequency integrated circuit for conducting frequency conversion to a low frequency band on an output signal of the first band pass filter, a second band pass filter for passing only a desired band in a transmission signal generated by the radio frequency integrated circuit, a power amplifier circuit for amplifying an output signal of the second band pass filter, and an isolator inserted so as to make it possible for the power amplifier circuit to conduct power amplification efficiently even if impedance of the antenna changes and so as to stabilize impedance of the antenna seen from the power amplifier, the duplexer passing only a desired band in an output signal of the isolator and outputting the passed signal to the antenna, wherein the module includes the duplexer, the low noise amplifier circuit, and the first band pass filter. As a result, it is possible to facilitate design and reduce the size and power dissipation of the radio frequency integrated circuit for full duplex system.

The module according to the present invention is formed to include a coupler for branching an output signal of the isolator and a detector circuit for detecting a signal level of an output of the coupler, wherein a bias current in the low noise amplifier circuit is increased when an output level of the detector circuit is high, and the bias current in the low noise amplifier circuit is decreased when the output level of the detector circuit is low. As a result, the power dissipation of the transceiver apparatus is decreased.

The module according to the present invention is formed to include the duplexer, the low noise amplifier circuit, the first band pass filter, the coupler, and the detector circuit. As a result, it is possible to facilitate design and reduce the size and power dissipation of the radio frequency integrated circuit for full duplex system.

The module is formed to include a plurality of duplexers, a plurality of low noise amplifier circuits, a plurality of first band pass filters, a radio frequency integrated circuit, a plurality of second band pass filters, a plurality of couplers, and a plurality of detector circuits so as to associate with a plurality of transceiver bands. As a result, it is possible to facilitate design and reduce the size and power dissipation of the radio frequency integrated circuit for full duplex system.

In addition, a control signal for turning on a low noise amplifier circuit intended only for a corresponding band among the low noise amplifier circuits is supplied from the radio frequency integrated circuit external to the module. As a result, it is possible to further facilitate design and reduce the size and power dissipation of the radio frequency integrated circuit for full duplex system.

As for mounting, a transceiver apparatus according to the present invention includes a switch for changing over a plurality of transceiver signals, a plurality of duplexers connected to the switch to conduct frequency separation on the transceiver signals, a plurality of low noise amplifiers for amplifying output receiver signals of the duplexers, and a plurality of band pass filters connected respectively to the low noise amplifiers, and the band pass filters output balanced signals. As a result, it is possible to reduce the size and distortion. Furthermore, it is possible to reduce the size and distortion by arranging balanced signal output terminals so as to be opposed to input terminals of direct conversion mixer circuits. Furthermore, it is possible to further reduce the size and stabilize the performance by forming the duplexers, the low noise amplifiers, and the band pass filters as monolithic ICs so as to associate a monolithic IC with each of a plurality of receiver bands. Furthermore, it is possible to further reduce the size by forming the whole of the switch, the duplexers, the low noise amplifiers, and the band pass filters as a monolithic IC.

According to the present invention, it is possible to facilitate design and reduce the size and power dissipation of the radio frequency integrated circuit for full duplex system.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an implementation method of a transceiver apparatus in Aspect 1;

FIG. 2 is a diagram showing an implementation method of a transceiver apparatus in Aspect 2;

FIG. 3A is a diagram showing a mechanism in which receiver sensitivity in a full duplex system is degraded by leak of a transmission signal to a receiver side;

FIG. 3B is a diagram showing a mechanism in which receiver sensitivity in a full duplex system is degraded by leak of a transmission signal to a receiver side;

FIG. 3C is a diagram showing a mechanism in which receiver sensitivity in a full duplex system is degraded by leak of a transmission signal to a receiver side;

FIG. 4 is a block diagram of a transceiver apparatus showing a conventional technique example;

FIG. 5 is a graph showing a bias current of an LNA 30 as a function of P_LNAout;

FIG. 6 is a graph showing a bias current of an LNA 30 as a function of Ltxrx;

FIG. 7 is a diagram showing an implementation method of a high frequency front-end module in Aspect 3;

FIG. 8 is a diagram showing an implementation method of a high frequency front-end module in Aspect 4;

FIG. 9 is a diagram showing an implementation method of a high frequency front-end module in Aspect 5;

FIG. 10 is a diagram showing an implementation method of a high frequency front-end module in Aspect 6;

FIG. 11 is a diagram showing an implementation method of a high frequency front-end module in Aspect 7;

FIG. 12 is a diagram showing an implementation method of a high frequency front-end module in Aspect 8;

FIG. 13 is a diagram showing an implementation method of a high frequency front-end module in Aspect 9; and

FIG. 14 is a diagram showing an implementation method of a high frequency front-end module in Aspect 10.

### DETAILED DESCRIPTION OF THE EMBODIMENTS

Hereafter, aspects of the present invention will be described.

[Aspect 1]

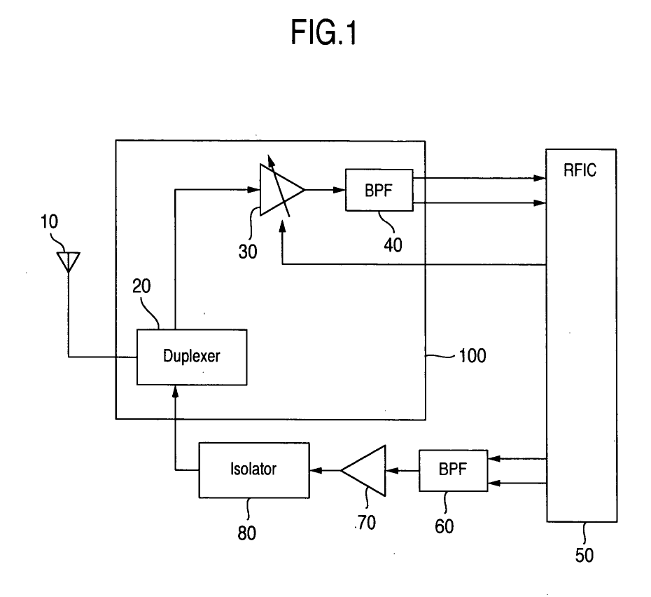

FIG. 1 is a block diagram showing Aspect 1 of a transceiver apparatus according to the present invention. In FIG. 1, reference numeral 10 denotes an antenna, 20 a duplexer, 30 an LNA, 40 a BPF, 50 an RFIC, 60 a BPF, 70 a PA, 80 an isolator, and 100 a high frequency front-end module. As for a radio frequency signal input from the antenna 10, signals in bands other than the desired band are suppressed by the duplexer 20. A resultant signal is input to the LNA 30. The LNA 30 amplifies the output signal of the duplexer 20 so as to prevent the signal-to-noise ratio (hereafter referred to as SNR) from being degraded as far as possible. An output signal of the LNA 30 is input to the BPF 40. The BPF 40 suppresses signals in bands other than the desired band, and outputs a resultant signal to the RFIC 50.

The RFIC 50 conducts processing on the radio frequency signal by using a receiver scheme such as the zero IF or the low IF. Furthermore, the RFIC 50 outputs signals for changing over a gain and a bias current of the LNA 30, and thereby changes over the gain and the bias current according to the receiver level.

Since the RFIC 50 is intended for the full duplex system, the RFIC 50 conducts transmission simultaneously with the reception. As for a transmission signal output from the RFIC 50, signals in bands other than the desired band are suppressed by the BPF 60. A resultant signal is input to the PA 70. The PA 70 amplifies the transmission signal to a desired level, and outputs a resultant signal to the isolator 80. The isolator 80 is provided to cause the PA 70 to be capable of conducting power amplification efficiently even under an impedance variation of the antenna 10. The impedance variation of the antenna 10 is caused when, for example, the portable telephone is used with the antenna in contact with the head.

An output of the isolator 80 is output from the antenna 10 via the duplexer 20.

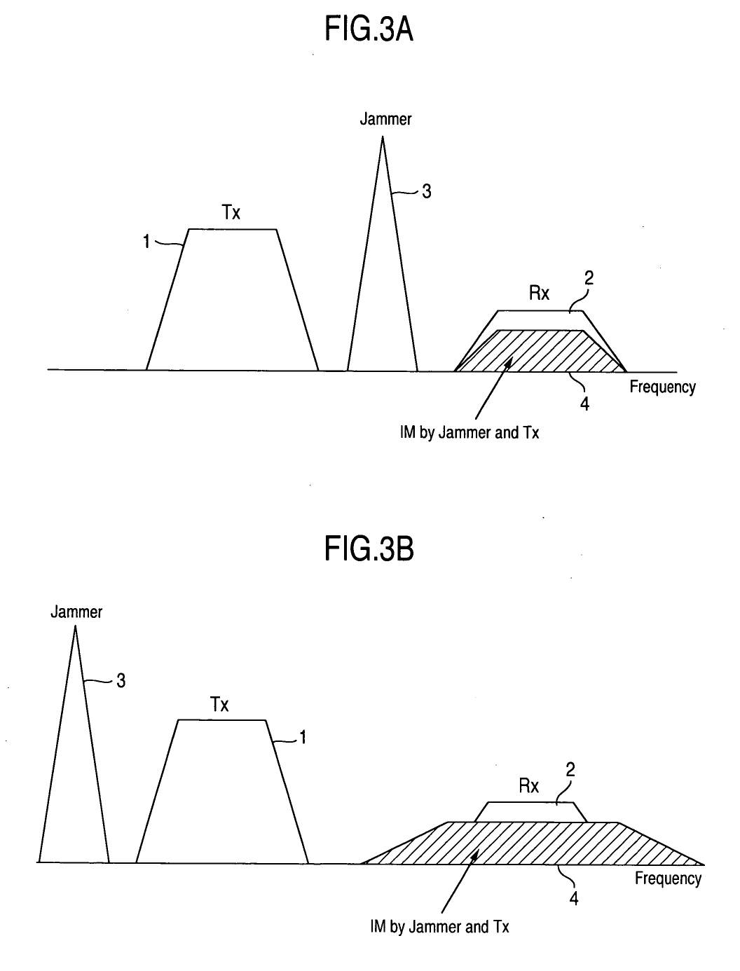

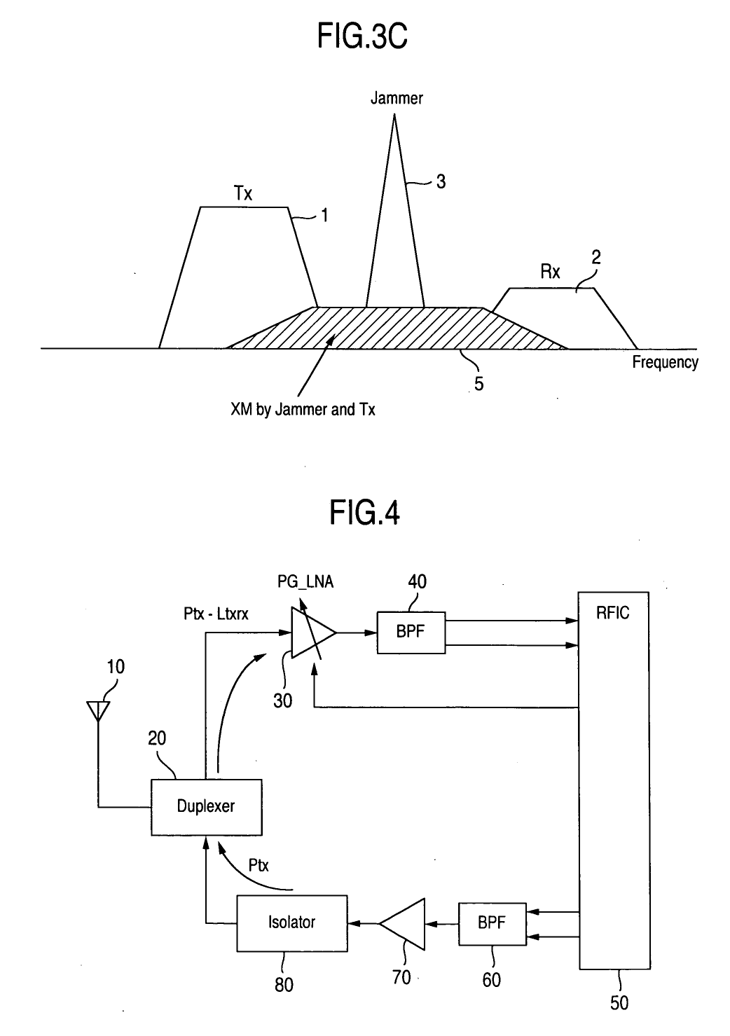

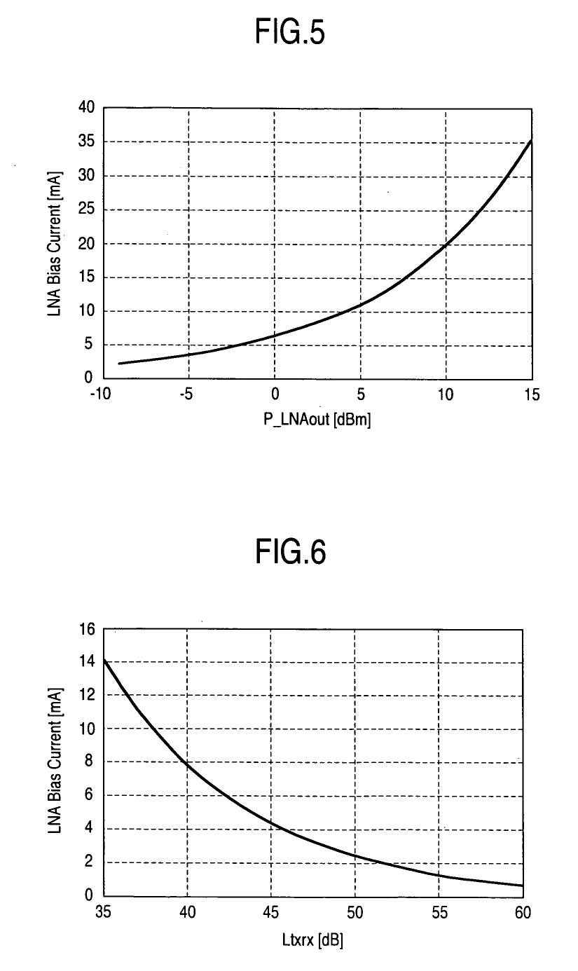

When seen from the receiver side (the input of the LNA 30), the duplexer 20 has an effect of suppressing the transmission signal (i.e., suppressing all signals in bands other than the receiver band). When seen from the transmission side (the output of the isolator 80), the duplexer 20 has an effect of suppressing spurious signals supplied from the receiver side (i.e., suppressing all signals in bands other than the transmission band). As a result, interference shown in FIGS. 3A-3C is reduced.

The high frequency front-end module 100 is formed by mounting the duplexer 20, the LNA 30 and the BPF 40 on a single module. For implementing a multi-band configuration, an antenna switch is disposed between the antenna 10 and the duplexer 20 to conduct signal changeover between bands, although not illustrated. In addition, power on/off changeover of the LNA 30 desired for each band is also conducted. An inter-band changeover signal for the antenna switch and the LNA 30 is sent from the RFIC 50.

Owing to the high frequency front-end module 100, the designer of the high frequency front-end module 100 participates in the optimum design of the bias current of the LNA 30. Therefore, it becomes easy to set the gain of the LNA 30 to a design value or stabilize the gain. On the other hand, since the leak of the transmission signal to the receiver side is sufficiently suppressed by the duplexer 20 and the BPF 40, it is not necessary to care about the leak level of the transmission signal to the receiver side at the time of design of the RFIC 50. Furthermore, since the LNA 30 is integrated into the high frequency front-end module 100, the low noise requirement for the RFIC 50 becomes weak and consequently it becomes possible to manufacture the RFIC 50 by using, for example, the low cost CMOS process.

If the FBAR or BAW filter technique or the like is used, the duplexer 20 and the BPF 40 can be integrated onto a silicon substrate on which the LNA 30 is manufactured. Thus, it is possible to form the high frequency front-end module 100 as a duplexer IC.

[Aspect 2]

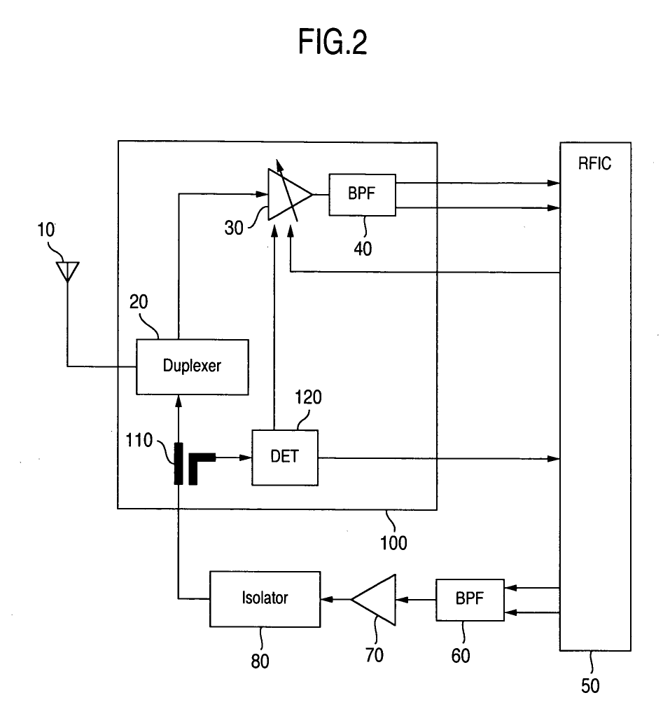

FIG. 2 is a block diagram showing Aspect 2 of a transceiver apparatus according to the present invention. In FIG. 2, components that conduct operations similar to those shown in FIG. 1 are denoted by the same numerals as those in FIG. 1, and description of them will be omitted. In FIG. 2, reference numeral 110 denotes a coupler and 120 denotes a power detector. If the leak level of the transmission signal to the receiver side is low, the bias current can be reduced and the power dissipation can be made lower in the LNA 30. Therefore, an output signal of the isolator 80 is branched by the coupler 110, and the transmission signal level is detected by the power detector 120. The bias current in the LNA 30 is controlled according to the detected level detected by the power detector 120. If an element that is low in threshold voltage and that does not dissipate power, such as a Schottky diode, is used in the power detector 120, the power dissipation can be further reduced.

On the other hand, it is rare to manufacture the RFIC 50 by using a process capable of using the Schottky diode. For integrating the power detector 120 into the RFIC 50, therefore, the power detector 120 must include an amplifier circuit, and consequently it is not suitable for low power dissipation.

According to the present aspect, it is possible to facilitate the design and reduce the size and power dissipation of RFIC 50 for full duplex system.

[Aspect 3]

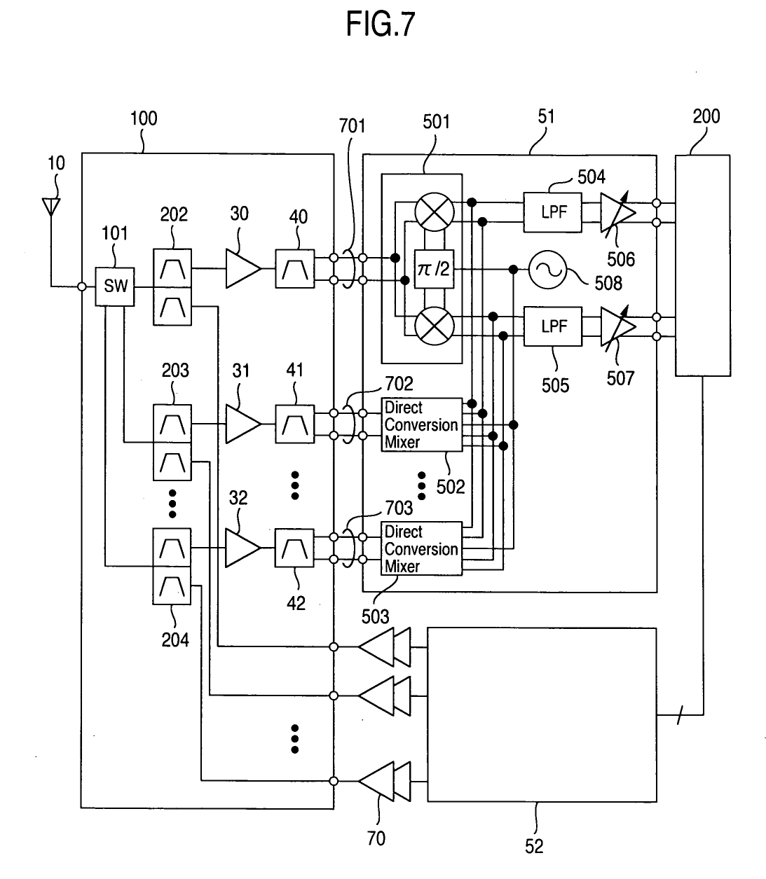

FIG. 7 is a block diagram showing Aspect 3 of a transceiver apparatus according to the present invention. In the present aspect, an example of a multi-band configuration is shown. It is noted that an isolator and a coupler as shown in FIG. 2 are provided here, though not shown. Full duplex communication is made possible by duplexers 202, 203 and 204 connected to a high frequency switch 101, which changes over a plurality of transceiver bands. Low noise amplifiers (LNAs) 30, 31 and 32 are connected respectively to receiver outputs of the duplexers, and band pass filters (BPFs) 40, 41 and 42 are connected respectively to the Low noise amplifiers (LNAs). By inserting the band pass filters, it becomes possible to improve distortion characteristics of the whole receiver circuit and reduce the dissipated power. The BPFs have balanced outputs, and it is suitable for connection to direct conversion mixers 501, 502 and 503. Because suppression of external noise mixed in, if any, conducted by the common mode rejection ratio of the mixers can be anticipated. A local oscillator 508 is connected to the direct conversion mixers. The local oscillator 508 generates the same oscillation frequency as the center frequency of waves desired to receive, and converts frequencies of the waves desired to receive into the baseband. The received signal converted into the baseband is coupled to variable gain amplifiers 506 and 507 respectively via LPFs 504 and 505 for channel selection. The received signal adjusted to a desired signal amplitude by the variable gain amplifiers is input to a baseband processor unit 200, and subject to demodulation and decoding processing.

As for the transmission side, a signal modulated from the baseband is converted to a desired high frequency modulation signal by a transmitter unit 52, amplified to a power level required for sending from the antenna by power amplifiers 70, and then input to transmission inputs of the duplexers.

In the present aspect, duplexers, LNAs, and BPFs are provided for respective receiver bands, connected to the high frequency switch for changeover, and formed as a module. Also in the case where multi-band configuration is used, it is possible to improve the distortion characteristics and reduce the dissipated current. Since the duplexers and the BPFs connected as input and output loads concerning the performance of the LNAs can be arranged so as to be adjacent to each other, an advantage of facilitating the optimization of the matching condition is obtained. Furthermore, since outputs of the BPFs are balanced, they can be advantageously connected to the direct conversion mixers 501, 502 and 503 connected outside the module and suppression of external noise can be anticipated. Furthermore, since the LNAs and the direct conversion mixers are separated from each other, semiconductor processes that are optimum respectively to the LNAs and the direct conversion mixers can be selected and advantages of increased degree of design freedom and improved performance are obtained.

By the way, in the present aspect, the RFIC 50 is shown to be divided to a direct conversion receiver 51 and a transmitter unit 52. Even if they are formed as a single chip, however, effects of the present invention are effective.

[Aspect 4]

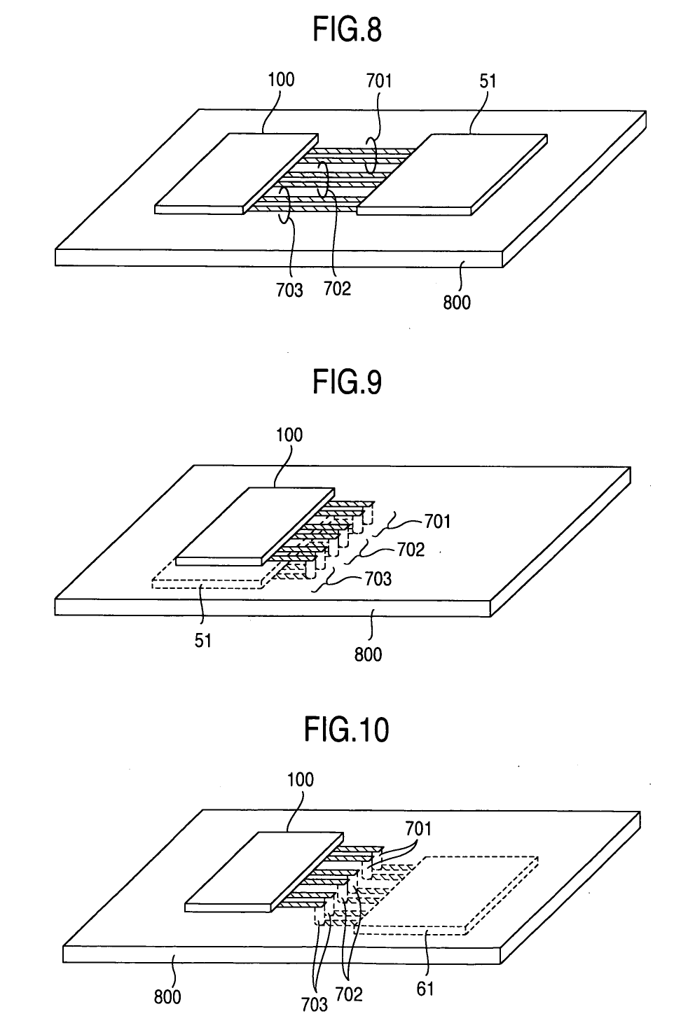

FIG. 8 is a structure diagram showing Aspect 4 of a transceiver apparatus according to the present invention. In the present aspect, an example of a mounting form corresponding to the multi-band configuration is shown. If the high frequency front end module 100 and the direct conversion receiver 51 are mounted on a mounting board 800, terminals of them are disposed so as to be opposed to each other. When the high frequency front end module and the direct conversion receiver are mounted on the same plane, therefore, they can be connected at a short distance without crossing of high frequency signal lines 701, 702 and 703. Since balanced signals pass through these high frequency signal lines, occurrence of imbalance in delay characteristics and loss characteristics of the line is undesirable because it leads to degradation in receiver characteristics. This can be avoided by the configuration in the present aspect.

[Aspect 5]

FIG. 9 is a structure diagram showing Aspect 5 of a transceiver apparatus according to the present invention. The present aspect is also an example of a mounting form corresponding to the multi-band configuration. It is now supposed that the high frequency front end module 100 and the direct conversion receiver 51 are mounted on opposite planes of the mounting board 800. At this time, terminals of the high frequency front end module 100 and the direct conversion receiver 51 are arranged so as to be opposed to each other on a perspective view as shown in FIG. 9. When conducting two-sided mounting, therefore, high frequency signal lines 701, 702 and 703 can be provided so as to have a short distance without crossing. High frequency signal lines on the mounting sides are connected through vias. Since vias have parasitic inductance components, however, signal delays and amplitude imbalance are caused according to the arrangement and consequently it is not desirable. According to the present aspect, wiring layout can be simplified, and consequently the degree of freedom of the layout is increased and the influence of parasitic inductance components on balanced signals can be suppressed.

[Aspect 6]

FIG. 10 is a structure diagram showing Aspect 6 of a transceiver apparatus according to the present invention. The present aspect is also an example of a mounting form corresponding to the multi-band configuration. It is now supposed that the high frequency front end module 100 and the direct conversion receiver 51 are mounted on opposite planes of the mounting board 800. At this time, terminals of the high frequency front end module 100 and the direct conversion receiver 51 are arranged so as to be opposed to each other on a perspective view as shown in FIG. 10 from the relation to mounting of other components. When conducting two-sided mounting, therefore, high frequency signal lines 701, 702 and 703 can be provided so as to have a short distance without crossing. High frequency signal lines on the mounting sides are connected through vias. Since vias have parasitic inductance components, however, signal delays and amplitude imbalance are caused according to the arrangement and consequently it is not desirable. According to the present aspect, wiring layout can be simplified, and consequently the degree of freedom of the layout is increased and the influence of parasitic inductance components on balanced signals can be suppressed.

[Aspect 7]

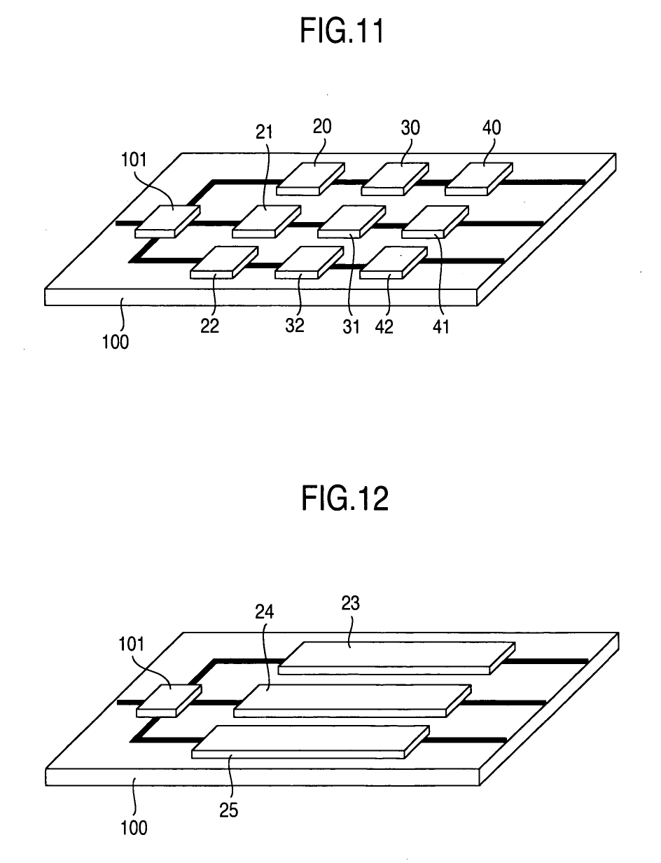

FIG. 11 is a structure diagram showing Aspect 7 of a transceiver apparatus according to the present invention. In the present aspect, an example of an internal configuration of a high frequency front end module corresponding to multi-band implementation is shown. The switch 101, the duplexers 20, 21 and 22, the LNAs 30, 31 and 32, and the BPFs 40, 41 and 42 are formed as separate chips in the module. By separating components, an effect of suppressing the leak of the transmission signal relating to the receiver distortion characteristics can be anticipated. Furthermore, when improving the performance for each of a plurality of receiver bands, re-design is conducted partially. Since it can be obviated by replacing a component only in a pertinent place, it is possible to obtain the degree of freedom of design and shorten the development term.

[Aspect 8]

FIG. 12 is a structure diagram showing Aspect 8 of a transceiver apparatus according to the present invention. In the present aspect as well, an example of the internal configuration of the high frequency front end module corresponding to multi-band implementation is shown. A duplexer, an LNA, and a BPF are integrated into a monolithic chip for each of a plurality of receiver bands. For example, if the duplexer and the BPF are formed using a BAR (Bulk Acoustic Resonator), which can be manufactured using a semiconductor process, monolithic implementation is possible. In this case, the manufacturing cost can be reduced. In addition, the performance can be stabilized owing to the monolithic implementation. Furthermore, the size and cost can be reduced owing to reduction in the number of packages for each chip. Even if the monolithic implementation is partially executed by restricting it to one or several receiver bands, similar effect are obtained. Even if the whole high frequency front end module inclusive of the high frequency switch 101 is implemented as a monolithic IC, further cost reduction can be anticipated.

[Aspect 9]

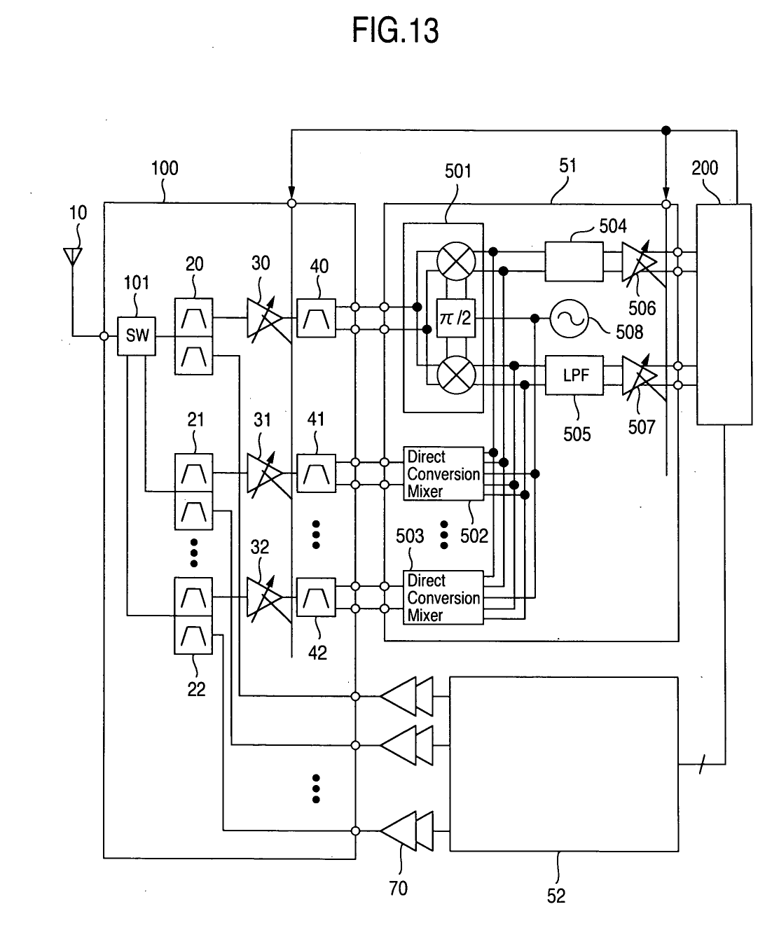

FIG. 13 is a block diagram showing Aspect 9 of a transceiver apparatus according to the present invention. It is noted that an isolator and a coupler as shown in FIG. 2 are provided here, though not shown. The present aspect shows a configuration example in the case where the LNA gain control is exercised by the baseband processor unit. The high frequency front end module has an input terminal for a gain control signal, and is capable of controlling gains and current values of respective LNAs according to an applied voltage, current or data. According to the present aspect, it is made possible to control the gains and current values of the LNAs included in the high frequency front end module from the outside of the module. This results in an advantage that the performance optimization of the whole receiver circuit can be implemented easily.

[Aspect 10]

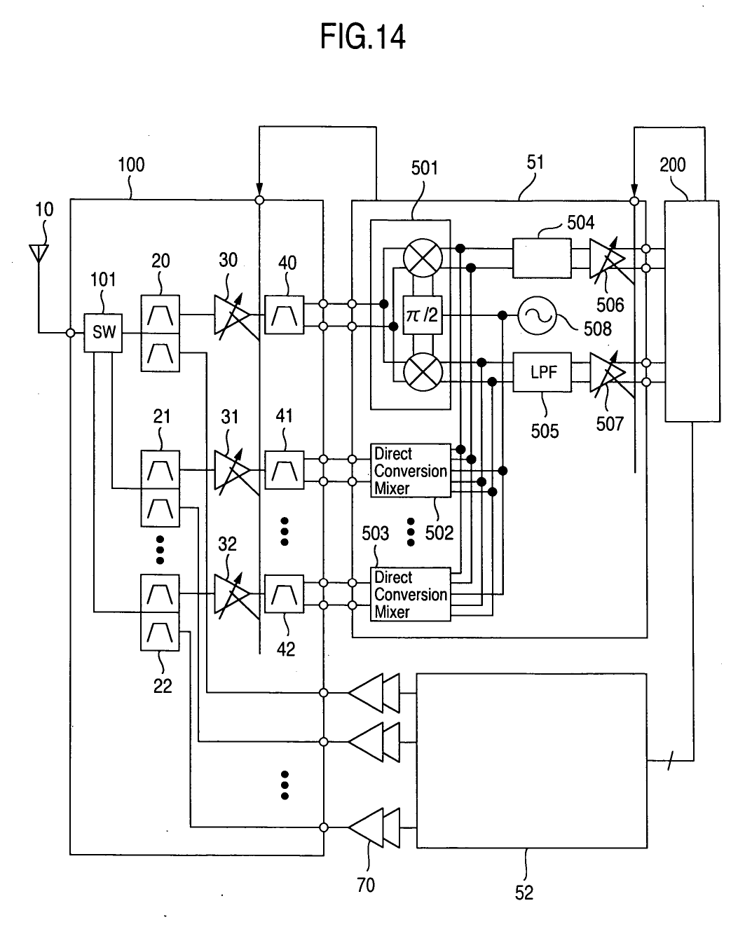

FIG. 14 is a block diagram showing Aspect 10 of a transceiver apparatus according to the present invention. It is noted that an isolator and a coupler as shown in FIG. 2 are provided here, though not shown. The present aspect shows a configuration example in the case where the LNA gain control is exercised by the RFIC (the direct conversion receiver 51). The high frequency front end module has an input terminal for a gain control signal, and is capable of controlling gains and current values of respective LNAs according to an applied voltage, current or data. According to the present aspect, it is made possible to control the gains and current values of the LNAs included in the high frequency front end module from the outside of the module. This results in an advantage that the performance optimization of the whole receiver circuit can be implemented easily. A transceiver apparatus using the module has an advantage that the load of the baseband processor unit can be reduced. Originally, the baseband processor unit controls the RFIC for the purpose of gain control of the variable gain amplifiers and frequency setting of the local oscillator. If means (not illustrated) for generating a control signal is provided in the RFIC, therefore, the gains and current values of the LNAs included in the high frequency front end module can be controlled from the outside of the module without newly generating a control signal in the baseband processor unit (without increasing processing).

As for industrial applicability, the present invention can be applied to CDMA portable telephone and the high frequency front end module used in the CDMA portable telephone.

It should be further understood by those skilled in the art that although the foregoing description has been made on embodiments of the invention, the invention is not limited thereto and various changes and modifications may be made without departing from the spirit of the invention and the scope of the appended claims.

1. A module that can be applied to a transceiver apparatus, the transceiver apparatus including an antenna, a duplexer for passing only a desired band in a signal from the antenna or a signal to the antenna, a low noise amplifier circuit for amplifying an output signal of the duplexer, a first band pass filter for passing only a desired band in an output signal of the low noise amplifier circuit, a radio frequency integrated circuit for conducting frequency conversion to a low frequency band on an output signal of the first band pass filter, a second band pass filter for passing only a desired band in a transmission signal generated by the radio frequency integrated circuit, a power amplifier circuit for amplifying an output signal of the second band pass filter, and an isolator inserted so as to make it possible for the power amplifier circuit to conduct power amplification efficiently even if impedance of the antenna changes and so as to stabilize impedance of the antenna seen from the power amplifier, the duplexer passing only a desired band in an output signal of the isolator and outputting the passed signal to the antenna,
wherein the module comprises the duplexer, the low noise amplifier circuit, and the first band pass filter.

2. A transceiver apparatus including an antenna, a duplexer for passing only a desired band in a signal from the antenna or a signal to the antenna, a low noise amplifier circuit for amplifying an output signal of the duplexer, a first band pass filter for passing only a desired band in an output signal of the low noise amplifier circuit, a radio frequency integrated circuit for conducting frequency conversion to a low frequency band on an output signal of the first band pass filter, a second band pass filter for passing only a desired band in a transmission signal generated by the radio frequency integrated circuit, a power amplifier circuit for amplifying an output signal of the second band pass filter, an isolator inserted so as to make it possible for the power amplifier circuit to conduct power amplification efficiently even if impedance of the antenna changes and so as to stabilize impedance of the antenna seen from the power amplifier, a coupler for branching an output signal of the isolator, and a detector circuit for detecting a signal level of an output of the coupler, the duplexer passing only a desired band in the output signal of the isolator and outputting the passed signal to the antenna,
wherein:
a bias current in the low noise amplifier circuit is increased when an output level of the detector circuit is high, and
the bias current in the low noise amplifier circuit is decreased when the output level of the detector circuit is low.

3. A module that can be applied to a transceiver apparatus, the transceiver apparatus including an antenna, a duplexer for passing only a desired band in a signal from the antenna or a signal to the antenna, a low noise amplifier circuit for amplifying an output signal of the duplexer, a first band pass filter for passing only a desired band in an output signal of the low noise amplifier circuit, a radio frequency integrated circuit for conducting frequency conversion to a low frequency band on an output signal of the first band pass filter, a second band pass filter for passing only a desired band in a transmission signal generated by the radio frequency integrated circuit, a power amplifier circuit for amplifying an output signal of the second band pass filter, an isolator inserted so as to make it possible for the power amplifier circuit to conduct power amplification efficiently even if impedance of the antenna changes and so as to stabilize impedance of the antenna seen from the power amplifier, a coupler for branching an output signal of the isolator, and a detector circuit for detecting a signal level of an output of the coupler, the duplexer passing only a desired band in the output signal of the isolator and outputting the passed signal to the antenna,
wherein:
the module comprises the duplexer, the low noise amplifier circuit, the first band pass filter, the coupler, and the detector circuit,
a bias current in the low noise amplifier circuit is increased when an output level of the detector circuit is high, and
the bias current in the low noise amplifier circuit is decreased when the output level of the detector circuit is low.

4. A module that can be applied to a transceiver apparatus, the transceiver apparatus including an antenna corresponding to operations in N (where N is an integer ≧2) transceiver bands, an antenna switch for changing over N signals from the antennas in the transceiver bands and N signals to the antennas in the transceiver bands, N duplexers for passing only desired bands in signals from the antenna switch or signals to the antenna switch, N low noise amplifier circuits intended for N receiver bands for amplifying output signals of the duplexers, N first band pass filters intended for N receiver bands for passing only desired bands in output signals of the low noise amplifier circuits, a radio frequency integrated circuit for conducting frequency conversion to a low frequency band on output signals of the first band pass filters, N second band pass filters for passing only desired bands in transmission signals generated by the radio frequency integrated circuit, N power amplifier circuits for amplifying output signals of the second band pass filters so as to be able to output the output signals of the second band pass filters from the antenna at a desired transmission level, N isolators intended for N transmitter bands and inserted so as to make it possible for the power amplifier circuits to conduct power amplification efficiently even if impedance of the antenna changes and so as to stabilize impedance of the antenna seen from the power amplifiers, N couplers intended for N transmitter bands for branching output signals of the isolators, and N detector circuits intended for N transmission bands for detecting signal levels of outputs of the couplers, increasing a bias current in the low noise amplifier circuit when the detected output level is high, and decreasing the bias current in the low noise amplifier circuit when the detected output level is low, the duplexers passing only a desired band in the output signals of the isolators and outputting the passed signal to the antenna,
wherein:
the module comprises the antenna switch, the duplexers, the low noise amplifier circuits, the first band pass filters, the couplers, and the detector circuits.

5. A module that can be applied to a transceiver apparatus according to claim 4, wherein a control signal for changing over the antenna switch to a corresponding band and a control signal for turning on a low noise amplifier circuit intended only for a corresponding band among the N low noise amplifier circuits are supplied from the radio frequency integrated circuit.

6. A module intended for transceiver apparatus, the module comprising:
a switch for changing over a plurality of transceiver signals;
a plurality of duplexers connected to the switch to conduct frequency separation on the transceiver signals;
a plurality of low noise amplifiers for amplifying output receiver signals of the duplexers; and
a plurality of band pass filters connected respectively to the low noise amplifiers,
wherein the band pass filters output balanced signals.

7. A module intended for transceiver apparatus according to claim 6, wherein:
outputs of the band pass filters are connected to receiver terminals of the module, and
when mounting the module on the same plane as that of a direct conversion receiver circuit externally connected to the module, the receiver terminals of the module and input terminals of the direct conversion receiver circuit are arranged so as to be opposed to each other.

8. A module intended for transceiver apparatus according to claim 6, wherein:
outputs of the band pass filters are connected to receiver terminals of the module, and
when mounting the module on a plane opposite to that of a direct conversion receiver circuit externally connected to the module, the receiver terminals of the module and input terminals of the direct conversion receiver circuit are arranged so as to be opposed to each other.

9. A module intended for transceiver apparatus according to claim 6, wherein the switch, the duplexers, the low noise amplifiers, and the band pass filters are formed as separate chips.

10. A module intended for transceiver apparatus according to claim 6, wherein the duplexers, the low noise amplifiers, and the band pass filters are formed as
monolithic ICs so as to associate a mononolithic IC with each of a plurality of receiver bands.

11. A module intended for transceiver apparatus according to claim 6, wherein the whole of the switch, the duplexers, the low noise amplifiers, and the band pass filters is formed as a monolithic IC.

12. A transceiver apparatus comprising:
a switch for changing over a plurality of transceiver signals;
a plurality of duplexers connected to the switch to conduct frequency separation on the transceiver signals;
a plurality of low noise amplifiers for amplifying output receiver signals of the duplexers; and
a plurality of band pass filters connected respectively to the low noise amplifiers,
wherein a module intended for the transceiver apparatus from which the band pass filters output balanced signals is connected to a direct conversion receiver circuit.

13. A transceiver apparatus according to claim 12, wherein when mounting the module intended for the transceiver apparatus on the same plane as that of the direct conversion receiver circuit, signals lines of the balanced signals output from the module and the direct conversion receiver circuit are arranged and connected so as to be opposed to each other.
